(19) United States
(12) Patent Application Publication
(10) Pub. No.: US 2019/0269260 A1
(43) Pub. Date: Sep. 5, 2019

(54) Board holder

(71) Applicant: PURE FIRE SURF, LLC, Wilmington, NC (US)

(72) Inventor: Cameron Smith, Wilmington, NC (US)

(21) Appl. No.: 16/275,852

(22) Filed: Feb. 14, 2019

Related U.S. Application Data
(60) Provisional application No. 62/638,645, filed on Mar. 5, 2018.

(51) Int. Cl. A47F 7/00; F16B 2/22; F16M 13/02

(52) U.S. Cl. CPC A47F 7/0042; F16B 2/22; B60R 9/08; A63C 2203/44; F16M 13/02

(57) ABSTRACT

A device for holding, storing and displaying surfboards, skateboards, snowboards, SUP's, wakeboards, skimboards, and other recreational sporting boards, mountable on walls, ceilings and other surfaces, and comprised of cast rubber, flexible polyurethane or similar material.

### CROSS REFERENCE TO RELATED APPLICATIONS

Not applicable

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

### Field of the Invention

The present invention relates to a storage and display holder for sporting boards.

### Background of the Invention

Devices for the storage and display of sporting boards such as surfboards, paddleboards and skateboards have been long known. Historically, such devices, or “racks”, have been made of metal, wood or other hardened materials with a high level of strength and durability, since the boards themselves tend to be weighty. These heavy, hard materials have a tendency to scratch, dent or otherwise mar the delicate surfaces of sports boards. In addition, such materials tend to have slick surfaces that can result in a hold on the board that can be unstable and lead to sliding or shifting.

Known racks also tend to involve multi-piece construction, often of a clamping-type design, requiring user assembly. Again, since the boards to be stored or displayed are often heavy and sizeable, the use of single, integrated components that fully holds and cushions the board has not been known. See, for example, U.S. Pub. 2007/0062992 to Hepworth et al. and and U.S. Pat. No. 5,582,044 to Grant.

What is needed is a simple, affordable, single or dual-component device for board storage that will also provide a stable and cushioning hold to avoid damaging the boards during storage. Such a device is described herein.

### BRIEF DESCRIPTION OF THE DRAWINGS

FIG. 1 is a line drawing evidencing a perspective view of the surfboard holder invention.

### DETAILED DESCRIPTION OF THE INVENTION

The invention is a board holder comprising either one or two molded components, each of which is designed to comprise a flat or specifically angled outer surface for mounting upon another surface, for example a wall, door or ceiling, and an inner surface rounded and contoured to match, as exactly as possible, the contours of a sporting board. Sporting boards to be employed in the invention can be surfboards, boogie boards, paddle boards, snowboards, skateboards and hover boards, among other varieties.

Sport boards can be made of a variety of different materials, but chief among them are fiberglass and filler materials covered with epoxy overlayers. These types of materials are susceptible to scratches, scrapes and dings from contact with other hard materials, such as those often used to fashion the storage racks that hold such boards. In most designs, an abrasion to the outer layer of the board may actually expose the foam interior to moisture, which eventually can compromise the integrity of the board and render it useless. This is especially true with boards used in water.

Applicant's board holder is to exhibit flexible elastomeric qualities and thus able to mold itself to, and hold without damaging, a sporting board. The elastomeric design lessens or eliminates the likelihood of board damage during storage or display. In one embodiment, the board holder is made of a commercially available natural or synthetic rubber. In practice, such rubber may be vulcanized or the surface of such rubber is treated for tackification by method(s) such as those described in U.S. Pat. No. 2,312,362 to Sarbach. Synthetic rubbers may be taken from the group comprising, but not limited to, styrene-butadiene rubber (SRB), isoprene, chloroprene and isbutylene or other, similar known substances.

In another embodiment, the board holder is made of a thermoplastic such as polyurethane or other reaction polymers. Injection molding is a preferred method of manufacture, and the use of thermosetting polymers are also preferred. Other methods of forming a holder design may include rotational molding, blow molding, compression molding, extrusion molding, thermoforming, as well as hand molding or carving.

The use of an elastomeric composition(s) allows the holder invention to conform to the shape and size of the board, and actively hold the board as opposed to merely supporting the board's weight, as known racks currently do. Such rack design may be altered slightly or substantially to interface with known board designs, such as shortboards, longboards, funboards, fish, guns, hybrids, snowboards, paddleboards and others, as each such design may have its own type of contouring.

The use of elastomeric compositions in an integrated block also results in the manifestation of unique designs in each individual unit. The sculpted shapes in the preferred materials will result in unique colors, patterns, and swirling. The holder units also lend themselves to the affixation or carving of logos, stamps, or other customized aesthetic components.

Thickness of the board holder is customizable depending on the weight and size of the board to be racked. Thickness in the ¾″-3″ range is preferred. Thickness of 1″-2″ is further preferred. Length of 3″-8″ is preferred, while width of 4″-10″ is preferred.

In another embodiment, the holder comprises a central metallic core around which the flexible, elastomeric composition is arranged. Such metal may be aluminum, steel or any other known metal or alloy with high-strength characteristics.

In another embodiment, the holder is elongated and includes two or more inner surfaces instead of one, allowing for the storage of multiple boards within the same holder.

In another embodiment, a method of use of two of the described board holder together to rack a single board. In yet another, a single holder may comprise a center piece connecting two separate holder components at either end, allowing a single board to be racked in two locations simultaneously.

In yet another embodiment, the elastomeric holder arrangement is redesigned to engage the top of a vehicle or back of a bicycle, enabling the user to transport one or more boards. Such a transportation design may employ the use of straps, clips, clamps, suction cups, or other means of fixation on the mounting surface, such means of fixation to interface with the cargo carrying component of a vehicle. Such embodiment would also include a means of securing the board within the inner surface, such as a rubberized clasp or bungee-style cord to secure the board from breaking free due to sudden movement.

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable Equivalents.

### DETAILED DESCRIPTION OF THE FIGURES

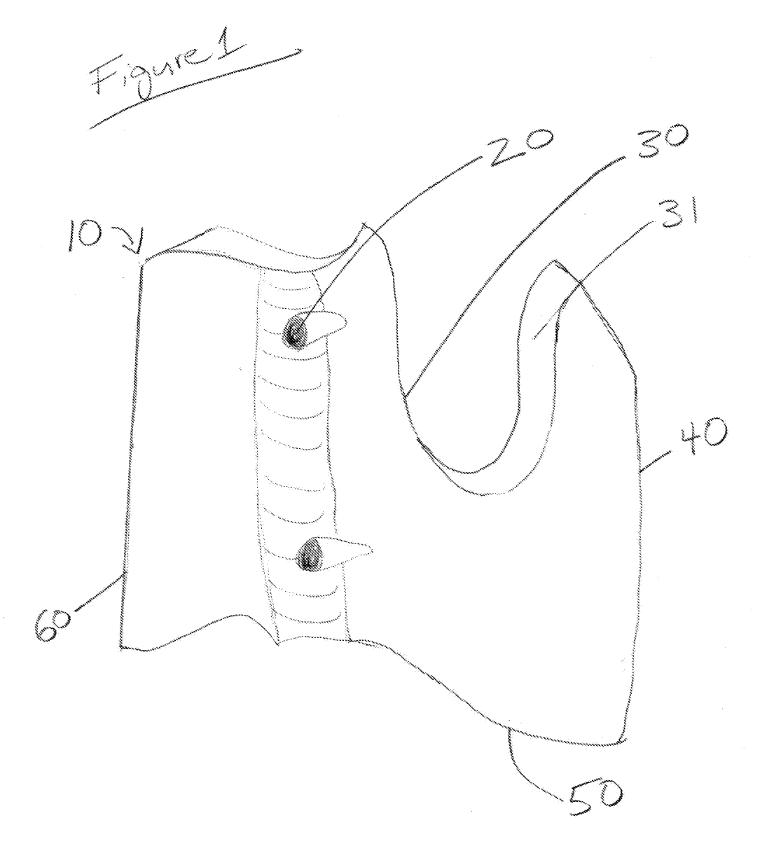

FIG. 1 is a photograph indicating two roughly similar board holder units 10. Each such unit is a single, integrated component comprised of a colored elastomeric material such as polyurethane. Per the annotations on the top holder unit, two fastener holes 20 on side of the holder are visible, while the corresponding two fastener holes are not pictured. In the pictured embodiment, such fastener holes would serve as conduits for screws or similar means of fastening the holder to the underlying wall, ceiling or other surface.

Also pictured is the inner surface 30 into which the sport board to be racked will be inserted, and the inner surface recurve 31 which serves to mold such inner surface to the contour of such board. In practice, multiple varieties of such contour or recurve would be available for multiple designs of board. Such surface recurve 31 ends in a point and continuous forward and outward to forward surface 40. Lower surface 50 is angled upward towards mounting surface 60, such that the weight of the racked board will be thrust in a rearward direction towards the mounting surface, lessening the stress on the forward portion of the holder, thus maintaining a better conforming grip between the inner surface 30 and the board.

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable Equivalents.

### PARTS OF THE INVENTION

10 Surf board holder

20 Fastener holes

30 Inner surface

31 Inner surface recurve

40 Forward surface

50 Lower surface

60 Mounting surface

I claim:

1. A board holder comprising a flat mounting surface and a contoured inner surface, comprised of a single piece of elastomeric material.

2. The board holder of claim 1, wherein the holder comprises two or more fastener holes allowing the holder to be fastened to a wall, ceiling, or similar surface.

3. The board holder of claim 1, wherein the inner surface comprises a recurve area allowing such inner surface to closely grip a sports board.

4. The board holder of claim 1, wherein the elastomeric material is taken from the group comprising natural rubber, synthetic rubber, polyurethane or another reaction polymer.

5. The board holder of claim 1, wherein the holder is formed by injection molding.

6. The board holder of claim 1, wherein the holder is formed by thermoforming.

7. The board holder of claim 1, wherein the holder comprises a width of 1″ to 2″.

8. The board holder of claim 1, wherein the holder comprises two separate inner surfaces for engaging two separate sports boards.

9. A method of using the board holder of claim 1 to store or display a sports board.

10. A method of using two board holders of claim 1 to store or display a single sports board.
